(19) United States
(12) Patent Application Publication
(10) Pub. No.: US 2026/0255442 A1
(43) Pub. Date: Aug. 27, 2026

(54) Increasing Traffic Separation Using Additional Traffic Identifiers (TIDS) in Wireless Communication Networks

(71) Applicant: Apple Inc., Cupertino, CA (US)

(72) Inventors: Abdel Karim Ajami, San Jose, CA (US); Oren Shani, Saratoga, CA (US); Jarkko L. Kneckt, Los Gatos, CA (US); Jinjing Jiang, Campbell, CA (US)

(21) Appl. No.: 19/537,369

(22) Filed: Feb. 11, 2026

Related U.S. Application Data
(60) Provisional application No. 63/761,828, filed on Feb. 21, 2025.

(51) Int. Cl. H04W 84/12

(52) U.S. Cl. CPC H04W 84/12

(57) ABSTRACT

Apparatuses, systems, and methods for increasing traffic separation using additional traffic identifiers in a wireless communications network are described including systems, methods, and mechanisms for transmitting and receiving a stream classification service request frame, wherein the stream classification service includes information providing a mapping of a traffic identifier (TID) value to a user priority (UP) value. In one example, a stream classification service request frame includes a Stream Classification Service (SCS) request frame. In one example, a stream classification service request frame includes a Mirrored Stream Classification Service (MSCS) request frame.

### PRIORITY DATA

This application claims the benefit of U.S. Provisional Patent Application Ser. No. 63/761,828, filed on Feb. 21, 2025 which is incorporated herein by reference.

### FIELD

The invention relates to wireless communications, and more particularly to apparatuses, systems, and methods for increasing traffic separation using additional traffic identifiers (TIDs) in wireless communications networks.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS), and are capable of operating sophisticated applications that utilize these functionalities. Additionally, there exist numerous different wireless communication technologies and standards.

Long Term Evolution (LTE), also referred to as the Evolved Universal Terrestrial Radio Access Network (E-UTRAN), has been the technology of choice for the majority of wireless network operators worldwide, providing mobile broadband data and high-speed Internet access to their subscriber base. LTE was first proposed in 2004 and was first standardized in 2008. Since then, as usage of wireless communication systems has expanded exponentially, demand has risen for wireless network operators to support a higher capacity for a higher density of mobile broadband users. Thus, in 2015 study of a new radio access technology began and, in 2017, a first release of the Third Generation Partnership Project (3GPP) Fifth Generation New Radio (5G NR) was standardized. 5th generation mobile networks or 5th generation wireless systems, referred to as 3GPP NR (otherwise known as 5G-NR or NR-5G for 5G New Radio, also simply referred to as NR). NR proposes a higher capacity for a higher density of mobile broadband users, also supporting device-to-device, ultra-reliable, and massive machine communications, as well as lower latency and lower battery consumption, than LTE standards.

5G-NR provides, as compared to LTE, a higher capacity for a higher density of mobile broadband users, while also supporting device-to-device, ultra-reliable, and massive machine type communications with lower latency and/or lower battery consumption. Further, NR may allow for more flexible UE scheduling as compared to current LTE. Consequently, efforts are being made in ongoing developments of 5G-NR to take advantage of higher throughputs possible at higher frequencies.

Wireless communication systems further include systems that enable wireless communications to occur over a Local Area Network (LAN). For example, the Wi-Fi Alliance defines Wi-Fi devices as any Wireless Local Area Network (WLAN) products that are based on the Institute of Electrical and Electronics Engineers' (IEEE) 802.11 standards, which may be referred to as IEEE 802.11 standards or 802.11 standards. The 802.11 standards enable may diverse devices, including, for example, smart phones and tablet computers, to communicate over a WLAN.

### SUMMARY

Embodiments relate to wireless communications, and more particularly to apparatuses, systems, and methods to increasing traffic separation using additional traffic identifiers (TIDs).

Embodiments relate to wireless communications, and more particularly to apparatuses, systems, and methods for a device configured for communicating in a wireless communication network, comprising: one or more processors, coupled to a memory, configured to: transmit a stream classification service request frame, wherein the stream classification service includes information providing a mapping of a traffic identifier (TID) value to a user priority (UP) value; and transmitting a stream with the traffic identifier (TID) value according to an access category provided by the user priority (UP) value.

Other embodiments relate to a wireless devices comprising: one or more processors, coupled to a memory, configured to: receive a stream classification service request frame, wherein the stream classification service includes information providing a mapping of a traffic identifier (TID) value to a user priority (UP) value; and transmitting a stream with the traffic identifier (TID) value according to an access category provided by the user priority (UP) value.

The techniques described herein may be implemented in and/or used with a number of different types of devices, including but not limited to base stations, access points, cellular phones, tablet computers, wearable computing devices, portable media players, vehicles, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1A illustrates an example of wireless communication system according to some embodiments.

FIG. 1B illustrates an example of a base station and an access point in communication with a wireless device, according to some embodiments.

FIGS. 2A-2B illustrate example block diagrams of a base station and an access point, according to some embodiments.

FIG. 3 illustrates an example block diagram of a server according to some embodiments.

FIG. 4 illustrates an example block diagram of a wireless device according to some embodiments.

FIG. 5 illustrates an example block diagram of wireless communication circuitry, according to some embodiments.

FIG. 6A illustrates an example of a 5G network architecture that incorporates both 3GPP (e.g., cellular) and Wireless Local Area Network (WLAN) access to the 5G CN, according to some embodiments.

FIG. 6B illustrates an example of a 5G network architecture that incorporates both dual 3GPP (e.g., LTE and 5G NR) access and Wireless Local Area Network (WLAN) access to the 5G CN, according to some embodiments.

FIG. 7 illustrates an example of a baseband processor architecture for a wireless device, according to some embodiments.

FIG. 8 illustrates an example of a wireless device in accordance with some embodiments.

FIG. 9 illustrates an example of baseband circuitry in accordance with some embodiments.

FIG. 10 illustrates an example of a Stream Classification Service (SCS) Request Frame in accordance with some embodiments.

FIG. 11 illustrates an example of a Mirrored Stream Classification Service (MSCS) Descriptor Element in accordance with some embodiments.

FIG. 12 illustrates an example timing diagram of Dynamic Mapping of traffic identifiers (TIDs) in a Stream Classification Service (SCS) Request, according to some embodiments.

FIG. 13 illustrates an example of a Mirrored Stream Classification Service (MSCS) Descriptor Element in accordance with some embodiments.

FIG. 14 illustrates an example timing diagram of Dynamic Mapping of traffic identifiers (TIDs) in a Mirrored Stream Classification Service (MSCS) Request, according to some embodiments.

FIG. 15 illustrates a block diagram of an example of a method for performing traffic separation using additional traffic identifiers in a wireless communications network, according to some embodiments.

FIG. 16 illustrates a block diagram of an example of a method for performing traffic separation using additional traffic identifiers in a wireless communications network, according to some embodiments.

FIG. 17 illustrates a block diagram of an example of a method 1700 for performing traffic separation at a wireless device using additional traffic identifiers in a wireless communications network, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

The following is a glossary of terms used in this disclosure:

Memory Medium-Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Wireless Device or Station (STA)—any of various types of computer systems devices which are mobile or portable and which performs wireless communications. Examples of STA devices include mobile telephones or smart phones (e.g., iPhone™, Android™-based phones), portable gaming devices (e.g., Nintendo Switch™), laptops, wearable devices (e.g., smart watch, smart glasses), PDAs, portable Internet devices, music players, data storage devices, other handheld devices, unmanned aerial vehicles (UAVs) (e.g., drones), UAV controllers (UACs), and so forth. In general, the term “STA” or “wireless device” can be broadly defined to encompass any electronic, computing, and/or telecommunications device (or combination of devices) which is easily transported by a user and capable of wireless communication.

Access Point—The term “Access Point” has the full breadth of its ordinary meaning and at least includes a device that connects wireless devices to a network, such as, for example, a wired network.

Base Station—The term “Base Station” has the full breadth of its ordinary meaning and at least includes a wireless communication station installed at a fixed location and used to communicate as part of a wireless telephone system or radio system.

Processing Element (or Processor)—refers to various elements or combinations of elements that are capable of performing a function in a device, such as a wireless device or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

IEEE 802.11—refers to technology based on the Institute of Electronics and Electrical Engineers (IEEE) 802.11 wireless standards such as 802.11a, 802.11.b, 802.11g, 802.11n (Wi-Fi 4), 802.11-2012, 802.11ac (Wi-Fi 5), 802.11ad, 802.11ax (Wi-Fi 6 and 6E), 802.11ay, 802.11be (Wi-Fi 7), 802.11bn (Wi-Fi 8) and/or other IEEE 802.11 standards. IEEE 802.11 technology may also be referred to as “Wi-Fi” or “wireless local area network (WLAN)” technology.

Wi-Fi—The term “Wi-Fi” (or WiFi) has the full breadth of its ordinary meaning and at least includes a wireless communication network or RAT that is serviced by wireless LAN (WLAN) access points, and which provides connectivity through these access points to the Internet. Most modern WLAN networks are based on IEEE 802.11 standards and are marketed under the name “Wi-Fi”. Thus, in some cases, a Wi-Fi network may be synonymous with a wireless LAN and as such, in some cases, the acronym WLAN may be used to refer to a Wi-Fi network.

3GPP Access—refers to accesses (e.g., radio access technologies) that are specified by the Third Generation Partnership Project (3GPP) standards. These accesses include, but are not limited to, GSM/GPRS, LTE, LTE-A, and/or 5G NR. In general, 3GPP access refers to various types of cellular access technologies.

Non-3GPP Access—refers any accesses (e.g., radio access technologies) that are not specified by 3GPP standards. These accesses include, but are not limited to, Wi-Fi, WLAN, and/or fixed networks. Non-3GPP accesses may be split into two categories, “trusted” and “untrusted”: Trusted non-3GPP accesses can interact directly with an evolved packet core (EPC) and/or a 5G core (5GC) whereas untrusted non-3GPP accesses interwork with the EPC/5GC via a network entity, such as an Evolved Packet Data Gateway and/or a 5G NR gateway. In general, non-3GPP access refers to various types of non-cellular access technologies.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system can update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as used by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

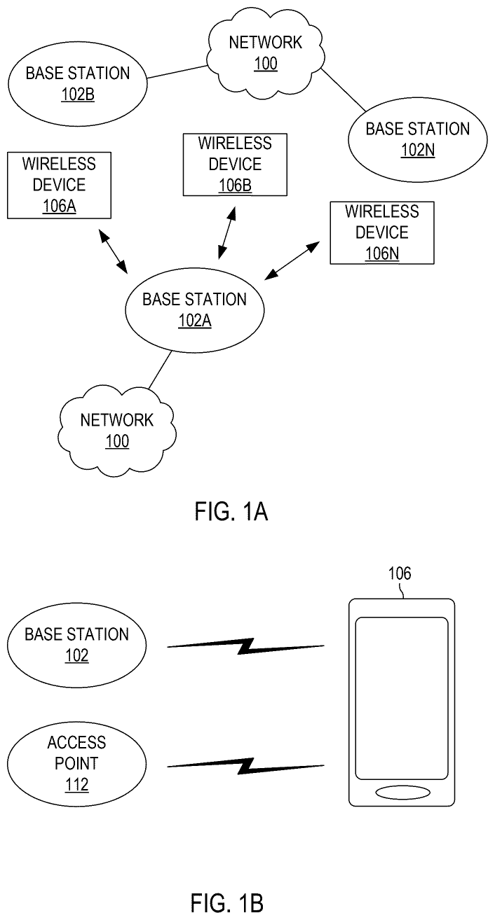

### FIGS. 1A and 1B: Communication Systems

FIG. 1A illustrates a simplified example of a wireless communication system, according to some embodiments. It is noted that the system of FIG. 1A is merely one example of a possible system, and that features of this disclosure may be implemented in any of the various systems, as desired.

As shown, the example wireless communication system includes a base station 102A which communicates over a transmission medium with one or more wireless devices referred to as a Station (STA) 106A, 106B, etc., through 106N. Thus, the user devices are referred to as STAs 106.

The base station (BS) 102A may be a base transceiver station (BTS) or cell site (a “cellular base station”) and may include hardware that enables wireless communication with the STAs 106A through 106N.

The communication area (or coverage area) of the base station may be referred to as a “cell.” The base station 102A and the STAs 106 may be configured to communicate over the transmission medium using any of various radio access technologies (RATs), also referred to as wireless communication technologies, or telecommunication standards, such as LTE, LTE-Advanced (LTE-A), 5G new radio (5G NR), 6G, etc. Note that if the base station 102A is implemented in the context of LTE (E-UTRAN), it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network (NW) 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide STAs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to STAs 106A-N and similar devices over a geographic area via one or more cellular communication standards.

Thus, while base station 102A may act as a “serving cell” for STAs 106A-N as illustrated in FIG. 1A, each STA 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1A might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transmission and reception points (TRPs). In addition, a wireless device capable of operating according to 5G NR may be connected to one or more TRPs within one or more gNBs.

Note that a STA 106 may be capable of communicating using multiple wireless communication standards. For example, the STA 106 may be configured to communicate using a wireless local area network (e.g., Wi-Fi) and/or a peer-to-peer wireless communication protocol (e.g., Bluetooth, Wi-Fi peer-to-peer, etc.) in addition to at least one cellular communication protocol (e.g., LTE, LTE-A, 5G NR, etc.). The STA 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

FIG. 1B illustrates STA 106 (e.g., one of the STAs 106A through 106N) in communication with a base station 102 and an access point 112, according to some embodiments. The STA 106 may be a device with both cellular communication capability and non-cellular communication capability (e.g., Bluetooth, Wi-Fi, and so forth) such as a mobile phone, a hand-held device, a computer or a tablet, or virtually any type of wireless device. It should be noted that according to 802.11 standards, a STA 106 in communication with an access point may be referred to as a client or station (STA).

The STA 106 may include a processor that is configured to execute program instructions stored in memory. The STA 106 may perform any of the method embodiments described herein by executing such stored instructions. Alternatively, or in addition, the STA 106 may include a programmable hardware element such as an FPGA (field-programmable gate array) that is configured to perform any of the method embodiments described herein, or any portion of any of the method embodiments described herein.

The STA 106 may include one or more antennas for communicating using one or more wireless communication protocols or technologies. In some embodiments, the STA 106 may be configured to communicate using, for example, using a single shared radio. A shared radio may couple to a single antenna, or may couple to multiple antennas (e.g., for MIMO) for performing wireless communications. In general, a radio may include any combination of a baseband processor (or other functionally similar components), analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the STA 106 may share one or more parts of a receive and/or transmit chain between multiple wireless communication technologies, such as those discussed above.

In some embodiments, the STA 106 may include separate transmit and/or receive chains (e.g., including separate antennas and other radio components) for each wireless communication protocol with which it is configured to communicate. As a further possibility, the STA 106 may include one or more radios which are shared between multiple wireless communication protocols, and one or more radios which are used exclusively by a single wireless communication protocol. For example, the STA 106 might include a shared radio for communicating using either of LTE (E-UTRAN) or 5G NR), and separate radios for communicating using each of Wi-Fi and Bluetooth. Other configurations are also possible.

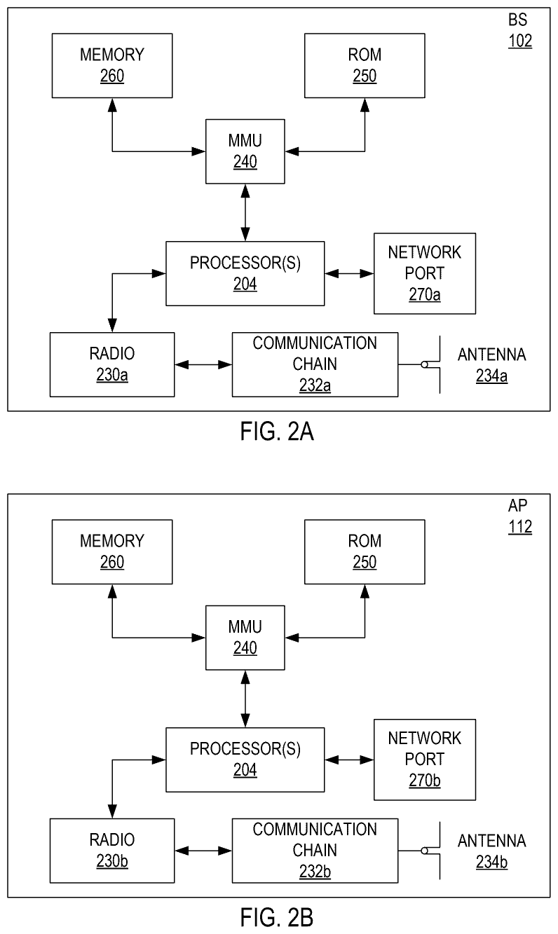

### FIGS. 2A-2B: Block Diagrams of a Base Station

FIGS. 2A-B illustrate example block diagrams of a base station 102 and an access point, according to some embodiments. It is noted that the base station of FIG. 2A is merely one example of a possible base station and FIG. 2B is merely one example of a possible access point. As shown, the base station 102 may include processor(s) 204 which may execute program instructions for the base station 102. The processor(s) 204 may also be coupled to memory management unit (MMU) 240, which may be configured to receive addresses from the processor(s) 204 and translate those addresses to locations in memory (e.g., memory 260 and read only memory (ROM) 250) or to other circuits or devices. Similarly, as shown, access point 112 may include processor(s) 204 coupled to memory management unit (MMU) 240 and memory (e.g., memory 260 and read only memory (ROM) 250).

The base station 102 may include at least one network port 270a. The network port 270a may be configured to couple to a telephone network and provide a plurality of devices, such as STAs 106, access to the telephone network as described above in FIGS. 1A and 1B.

The network port 270a (or an additional network port) may also or alternatively be configured to couple to a cellular network, e.g., a core network of a cellular service provider. The core network may provide mobility related services and/or other services to a plurality of devices, such as STAs 106. In some cases, the network port 270a may couple to a telephone network via the core network, and/or the core network may provide a telephone network (e.g., among other STAs serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transmission and reception points (TRPs). In addition, a wireless device capable of operating according to 5G NR may be connected to one or more TRPs within one or more gNBs.

The access point 112 may include at least one network port 270b. The network port 270b may be configured to couple to a wired or wireless network and provide a plurality of devices, such as STAs 106, access to the wired network, including for example, the Internet, as described above in FIGS. 1A and 1B. In some embodiments, access point 112 may be a Wi-Fi access point and in some embodiments the network port 270b may include an Ethernet port.

The base station 102 may include at least one antenna 234a, and possibly multiple antennas. The at least one antenna 234a may be configured to operate as a wireless transceiver and may be further configured to communicate with STAs 106 via radio 230a. The antenna 234a communicates with the radio 230a via communication chain 232a. Communication chain 232a may be a receive chain, a transmit chain or both. The radio 230a may be configured to communicate via various wireless communication standards, including, but not limited to, 5G NR, LTE, LTE-A, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, etc.).

The access point 112 may include at least one antenna 234b, and possibly multiple antennas. The at least one antenna 234b may be configured to operate as a wireless transceiver and may be further configured to communicate with STAs 106 via radio 230b. The antenna 234b communicates with the radio 230b via communication chain 232b. Communication chain 232b may be a receive chain, a transmit chain or both. The radio 230b may be configured to communicate via various wireless communication standards, including, but not limited to, Wi-Fi, i.e., IEEE 802.11 standards. In some embodiments, the radio 230a may be further configured to communicate via various wireless communication standards, including, but not limited to, 5G NR, LTE, etc.

The access point 112 may be configured to communicate wirelessly using multiple wireless and wired communication standards. In some instances, the access point 112 may include multiple radios and network ports, which may enable the access point 112 to communicate according to multiple wireless and wired communication technologies.

As described further herein, the BS 102 and AP 112 may include hardware and software components for implementing or supporting implementation of features described herein. The processors 204 of the base station 102 and AP 112 may be configured to implement or support implementation of part, or all of the methods described herein, e.g., by executing program instructions stored on a memory medium (e.g., a non-transitory computer-readable memory medium). Alternatively, the processor 204 may be configured as a programmable hardware element, such as an FPGA (Field Programmable Gate Array), or as an ASIC (Application Specific Integrated Circuit), or a combination thereof. Alternatively (or in addition) the processor 204 of the BS 102, in conjunction with one or more of the other components 230a, 232a, 234a, 240, 250, 260, 270a may be configured to implement or support implementation of part or all of the features described herein. Alternatively (or in addition) the processor 204 of the AP 112, in conjunction with one or more of the other components 230b, 232b, 234b, 240, 250, 260, 270b may be configured to implement or support implementation of part or all of the features described herein.

In addition, as described herein, processor(s) 204 may be comprised of one or more processing elements. In other words, one or more processing elements may be included in processor(s) 204. Thus, processor(s) 204 may include one or more integrated circuits (ICs) that are configured to perform the functions of processor(s) 204. In addition, each integrated circuit may include circuitry (e.g., first circuitry, second circuitry, etc.) configured to perform the functions of processor(s) 204.

Further, as described herein, radios 230a and 230b may be comprised of one or more processing elements. In other words, one or more processing elements may be included in radios 230a and 230b. Thus, radios 230a and 230b may include one or more integrated circuits (ICs) that are configured to perform the functions of radios 230a and 230b. In addition, each integrated circuit may include circuitry (e.g., first circuitry, second circuitry, etc.) configured to perform the functions of radios 230a and 230b.

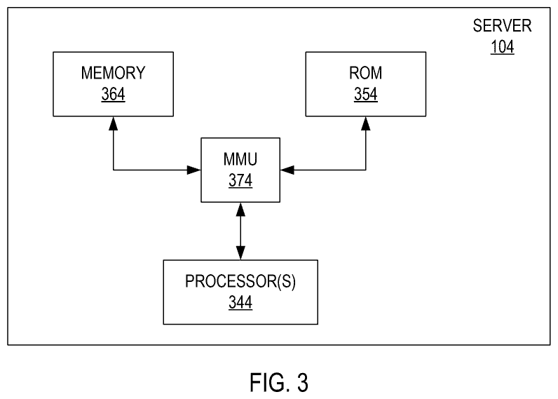

### FIG. 3: Block Diagram of a Server

FIG. 3 illustrates an example block diagram of a server 104, according to some embodiments. It is noted that the server of FIG. 3 is merely one example of a possible server. As shown, the server 104 may include processor(s) 344 which may execute program instructions for the server 104. The processor(s) 344 may also be coupled to memory management unit (MMU) 374, which may be configured to receive addresses from the processor(s) 344 and translate those addresses to locations in memory (e.g., memory 364 and read only memory (ROM) 354) or to other circuits or devices.

The server 104 may be configured to provide a plurality of devices, such as base station 102, access point 112, and STAs 106 access to network functions, e.g., as further described herein.

In some embodiments, the server 104 may be part of a radio access network, such as a 5G New Radio (5G NR) radio access network. In some embodiments, the server 104 may be connected to a legacy evolved packet core (EPC) network and/or to a NR core (NRC) network. In some embodiments, the server 104 may be part of a network, such as, for example, a wired network, which to accessed using an access point.

As described further subsequently herein, the server 104 may include hardware and software components for implementing or supporting implementation of features described herein. The processor 344 of the server 104 may be configured to implement or support implementation of part or all of the methods described herein, e.g., by executing program instructions stored on a memory medium (e.g., a non-transitory computer-readable memory medium). Alternatively, the processor 344 may be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 may be configured to implement or support implementation of part or all of the features described herein.

In addition, as described herein, processor(s) 344 may be comprised of one or more processing elements. In other words, one or more processing elements may be included in processor(s) 344. Thus, processor(s) 344 may include one or more integrated circuits (ICs) that are configured to perform the functions of processor(s) 344. In addition, each integrated circuit may include circuitry (e.g., first circuitry, second circuitry, etc.) configured to perform the functions of processor(s) 344.

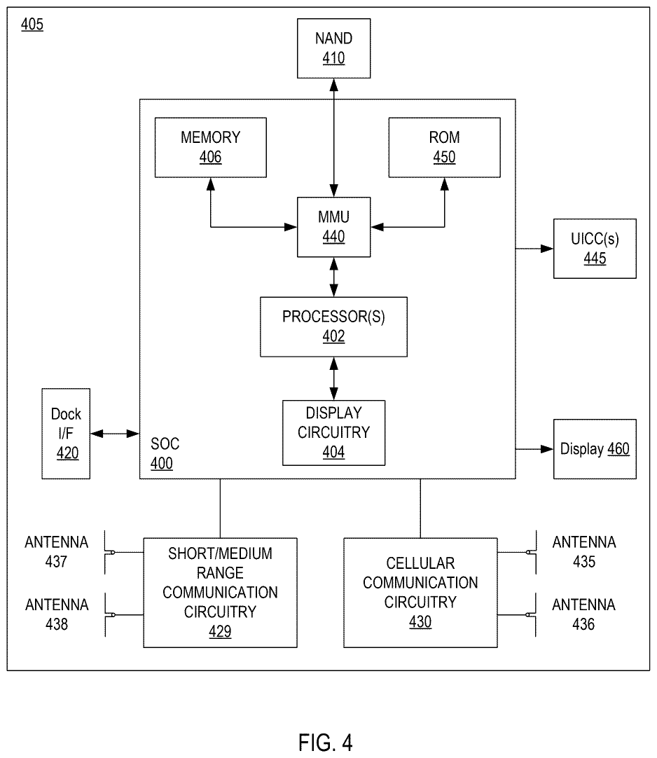

### FIG. 4: Block Diagram of a STA

FIG. 4 illustrates an example simplified block diagram of a STA 106, according to some embodiments. It is noted that the block diagram of the communication device of FIG. 4 is only one example of a possible communication device. According to embodiments, communication device 405 may be STA, a mobile device or mobile station, a wireless device or wireless station, a desktop computer or computing device, a mobile computing device (e.g., a laptop, notebook, or portable computing device), a tablet, an unmanned aerial vehicle (UAV), a UAV controller (UAC) and/or a combination of devices, among other devices. As shown, the STA 106 may include a set of components 400 configured to perform core functions. For example, this set of components may be implemented as a system on chip (SOC), which may include portions for various purposes. Alternatively, this set of components 400 may be implemented as separate components or groups of components for the various purposes. The set of components 400 may be coupled (e.g., communicatively; directly or indirectly) to various other circuits of the STA 106.

For example, the STA 106 may include various types of memory (e.g., including NAND flash 410), an input/output interface such as connector I/F 420 (e.g., for connecting to a computer system; dock; charging station; input devices, such as a microphone, camera, keyboard; output devices, such as speakers; etc.), the display 460, which may be integrated with or external to the communication device 405, and cellular communication circuitry 430 such as for 5G NR, LTE, etc., and short to medium range wireless communication circuitry 429 (e.g., Bluetooth™ and WLAN circuitry). In some embodiments, STA 106 may include wired communication circuitry (not shown), such as a network interface card, e.g., for Ethernet.

The cellular communication circuitry 430 may couple (e.g., communicatively; directly or indirectly) to one or more antennas, such as antennas 435 and 436 as shown. The short to medium range wireless communication circuitry 429 may also couple (e.g., communicatively; directly or indirectly) to one or more antennas, such as antennas 437 and 438 as shown. Alternatively, the short to medium range wireless communication circuitry 429 may couple (e.g., communicatively; directly or indirectly) to the antennas 435 and 436 in addition to, or instead of, coupling (e.g., communicatively; directly or indirectly) to the antennas 437 and 438. The short to medium range wireless communication circuitry 429 and/or cellular communication circuitry 430 may include multiple receive chains and/or multiple transmit chains for receiving and/or transmitting multiple spatial streams, such as in a multiple-input multiple output (MIMO) configuration.

In some embodiments, as further described below, cellular communication circuitry 430 may include dedicated receive chains (including and/or coupled to, e.g., communicatively; directly or indirectly. dedicated processors and/or radios) for multiple RATs (e.g., a first receive chain for LTE and a second receive chain for 5G NR). In addition, in some embodiments, cellular communication circuitry 430 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 405 may also include and/or be configured for use with one or more user interface elements. The user interface elements may include any of various elements, such as display 460 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The STA 106 may further include one or more smart cards that include SIM (Subscriber Identity Module) functionality, such as one or more UICC(s) (Universal Integrated Circuit Card(s)) cards 445. Note that the term “SIM” or “SIM entity” is intended to include any of various types of SIM implementations or SIM functionality, such as the one or more UICC(s) cards 445, one or more eUICCs, one or more eSIMs, either removable or embedded, etc. In some embodiments, the STA 106 may include at least two SIMs. Each SIM may execute one or more SIM applications and/or otherwise implement SIM functionality. Thus, each SIM may be a single smart card that may be embedded, e.g., may be soldered onto a circuit board in the STA 106, or each SIM (UICC) may be implemented as a removable smart card. Thus, the SIM(s) may be one or more removable smart cards (such as UICC cards, which are sometimes referred to as “SIM cards”), and/or the (UICCs) may be one or more embedded cards (such as embedded UICCs (eUICCs), which are sometimes referred to as “eSIMs” or “eSIM cards”). In some embodiments (such as when the SIM(s) include an eUICC), one or more of the SIM(s) may implement embedded SIM (eSIM) functionality; in such an embodiment, a single one of the SIM(s) may execute multiple SIM applications. Each of the SIMs may include components such as a processor and/or a memory; instructions for performing SIM/eSIM functionality may be stored in the memory and executed by the processor. In some embodiments, the STA 106 may include a combination of removable smart cards and fixed/non-removable smart cards (such as one or more eUICC cards that implement eSIM functionality), as desired. For example, the STA 106 may comprise two embedded SIMs, two removable SIMs, or a combination of one embedded SIMs and one removable SIMs. Various other SIM configurations are also contemplated.

As shown, the SOC 400 may include processor(s) 402, which may execute program instructions for the communication device 405 and display circuitry 404, which may perform graphics processing and provide display signals to the display 460. The processor(s) 402 may also be coupled to memory management unit (MMU) 440, which may be configured to receive addresses from the processor(s) 402 and translate those addresses to locations in memory (e.g., memory 406, read only memory (ROM) 450, NAND flash memory 410) and/or to other circuits or devices, such as the display circuitry 404, short to medium range wireless communication circuitry 429, cellular communication circuitry 430, connector I/F 420, and/or display 460. The MMU 440 may be configured to perform memory protection and page table translation or set up. In some embodiments, the MMU 440 may be included as a portion of the processor(s) 402.

As noted above, the communication device 405 may be configured to communicate using wireless and/or wired communication circuitry. The communication device 405 may be configured to perform methods for increasing traffic separation using additional traffic identifiers (TIDs), as further described herein.

As described herein, the STA 106 may include hardware and software components for implementing the above features for a STA 106 to communicate a scheduling profile for power savings to a network. The processor 402 of the STA 106 may be configured to implement part or all of the features described herein, e.g., by executing program instructions stored on a memory medium (e.g., a non-transitory computer-readable memory medium). Alternatively (or in addition), processor 402 may be configured as a programmable hardware element, such as an FPGA (Field Programmable Gate Array), or as an ASIC (Application Specific Integrated Circuit). Alternatively (or in addition) the processor 402 of the communication device 405, in conjunction with one or more of the other components 400, 404, 406, 410, 420, 429, 430, 440, 445, 450, 460 may be configured to implement part or all of the features described herein.

In addition, as described herein, processor 402 may include one or more processing elements. Thus, processor 402 may include one or more integrated circuits (ICs) that are configured to perform the functions of processor 402. In addition, each integrated circuit may include circuitry (e.g., first circuitry, second circuitry, etc.) configured to perform the functions of processor(s) 402.

Further, as described herein, cellular communication circuitry 430 and short to medium range wireless communication circuitry 429 may each include one or more processing elements. In other words, one or more processing elements may be included in cellular communication circuitry 430 and, similarly, one or more processing elements may be included in short to medium range wireless communication circuitry 429. Thus, cellular communication circuitry 430 may include one or more integrated circuits (ICs) that are configured to perform the functions of cellular communication circuitry 430. In addition, each integrated circuit may include circuitry (e.g., first circuitry, second circuitry, etc.) configured to perform the functions of cellular communication circuitry 430. Similarly, the short to medium range wireless communication circuitry 429 may include one or more ICs that are configured to perform the functions of short to medium range wireless communication circuitry 429. In addition, each integrated circuit may include circuitry (e.g., first circuitry, second circuitry, etc.) configured to perform the functions of short to medium range wireless communication circuitry 429.

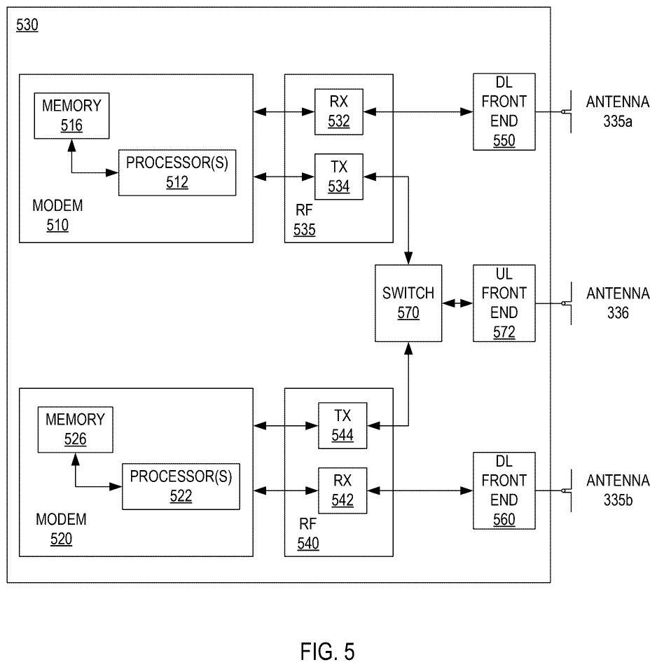

### FIG. 5: Block Diagram of Wireless Communication Circuitry

FIG. 5 illustrates an example simplified block diagram of wireless communication circuitry, according to some embodiments. It is noted that the block diagram of the wireless communication circuitry of FIG. 5 is only one example of a possible wireless communication circuit. According to embodiments, wireless communication circuitry 530, which may be cellular communication circuitry 430 or short to medium range wireless communication circuitry 429 may be included in a communication device, such as communication device 405 described above. As noted above, STA 106 may be a STA, a mobile device or mobile station, a wireless device or wireless station, a desktop computer or computing device, a mobile computing device (e.g., a laptop, notebook, or portable computing device), a tablet and/or a combination of devices, among other devices.

The wireless communication circuitry 530 may couple (e.g., communicatively; directly or indirectly) to one or more antennas, such as antennas 435, 436, 437, and 438 as shown (in FIG. 4). In some embodiments, wireless communication circuitry 530 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, wireless communication circuitry 530 may include a modem 510 and a modem 520. Modem 510 may be configured for communications according to a first RAT, e.g., such as LTE or LTE-A, and modem 520 may be configured for communications according to a second RAT, e.g., such as 5G NR. Further, in some embodiments, wireless communication circuitry 530 may include dedicated receive chains for WLAN communications.

As shown, modem 510 may include one or more processors 512 and a memory 516 in communication with processors 512. Modem 510 may be in communication with a radio frequency (RF) front end 535. RF front end 535 may include circuitry for transmitting and receiving radio signals. For example, RF front end 535 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when wireless communication circuitry 530 receives instructions to transmit according to a first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when wireless communication circuitry 530 receives instructions to transmit according to a WLAN (or second RAT) (e.g., as supported via modem 520), switch 570 may be switched to a second state that allows modem 520 to transmit signals according to the WLAN (e.g., via a transmit chain that includes transmit circuitry 544 and UL front end 572).

In some embodiments, the wireless communication circuitry 530 may be configured to perform methods for increasing traffic separation using additional traffic identifiers (TIDs), as further described herein.

As described herein, the modem 510 may include hardware and software components for implementing the above features or for time division multiplexing UL data for NSA NR operations, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

As described herein, the modem 520 may include hardware and software components for implementing the above features for performing methods for increasing traffic separation using additional traffic identifiers (TIDs), as further described herein, as well as the various other techniques described herein. The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

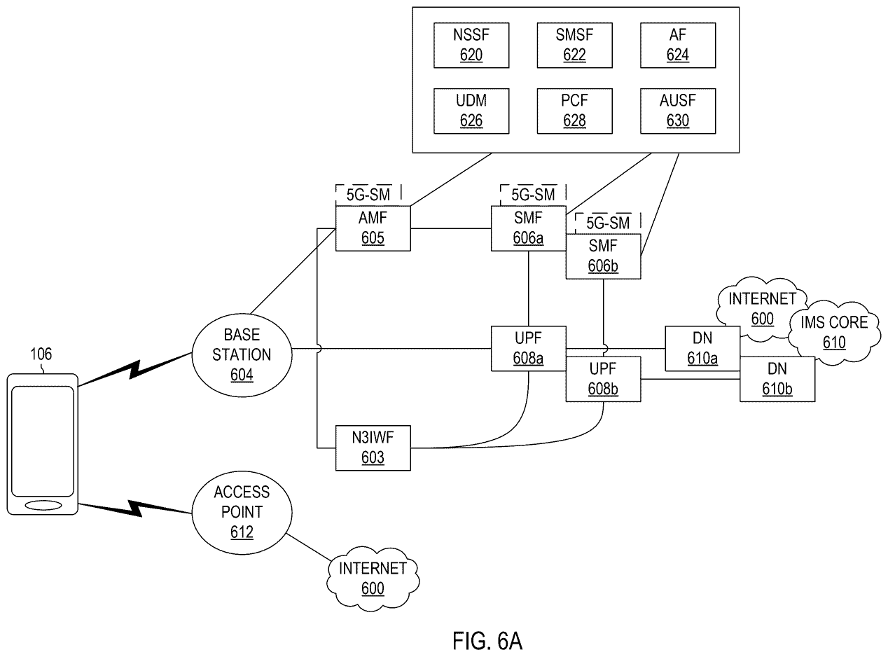

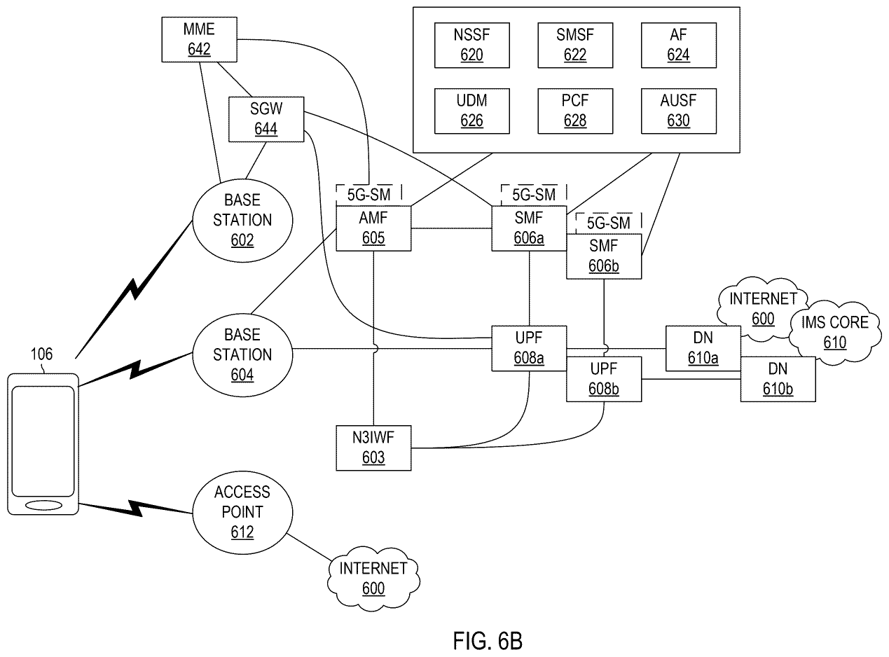

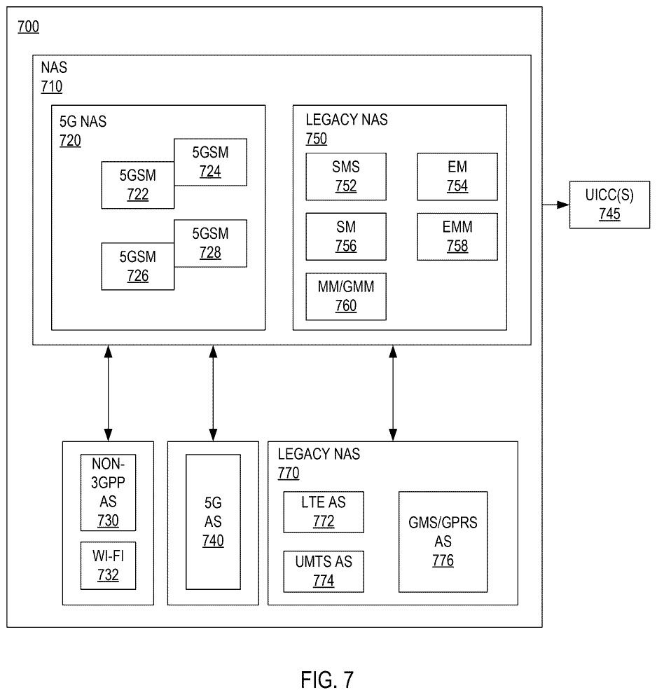

FIGS. 6A, 6B, and 7: 5G Core Network Architecture—Interworking with Wi-Fi

In some embodiments, the 5G core network (CN) may be accessed via (or through) a cellular connection/interface (e.g., via a 3GPP communication architecture/protocol) and a wireless local access network (WLAN) connection/interface (e.g., an architecture/protocol such as Wi-Fi connection). FIG. 6A illustrates an example of a 5G network architecture that incorporates both 3GPP (e.g., cellular) and wireless local access network (WLAN) access to the 5G CN, according to some embodiments. As shown, a wireless device (e.g., such as STA 106) may access the 5G CN through both a radio access network (RAN, e.g., such as gNB 604, which may be a base station 102) and an access point, such as AP 612. The AP 612 may include a connection to the Internet 600 as well as a connection to a non-3GPP inter-working function (N3IWF) 603 network entity. The N3IWF may include a connection to a core access and mobility management function (AMF) 605 of the 5G CN. The AMF 605 may include an instance of a 5G mobility management (5G MM) function associated with the STA 106. In addition, the RAN (e.g., gNB 604) may also have a connection to the AMF 605. Thus, the 5G CN may support unified authentication over both connections as well as allow simultaneous registration for STA 106 access via both gNB 604 and AP 612. As shown, the AMF 605 may include one or more functional entities associated with the 5G CN (e.g., network slice selection function (NSSF) 620, short message service function (SMSF) 622, application function (AF) 624, unified data management (UDM) 626, policy control function (PCF) 628, and/or authentication server function (AUSF) 630). Note that these functional entities may also be supported by a session management function (SMF) 606a and an SMF 606b of the 5G CN. The AMF 605 may be connected to (or in communication with) the SMF 606a. Further, the gNB 604 may in communication with (or connected to) a user plane function (UPF) 608a that may also be communication with the SMF 606a. Similarly, the N3IWF 603 may be communicating with a UPF 608b that may also be communicating with the SMF 606b. Both UPFs may be communicating with the data network (e.g., DN 610a and 610b) and/or the Internet 600 and Internet Protocol (IP) Multimedia Subsystem/IP Multimedia Core Network Subsystem (IMS) core network 610.

FIG. 6B illustrates an example of a 5G network architecture that incorporates both dual 3GPP (e.g., LTE and 5G NR) access and wireless local access network (WLAN) to the 5G CN, according to some embodiments. As shown, a wireless device (e.g., such as STA 106) may access the 5G CN through both a radio access network (RAN, e.g., such as gNB 604 or eNB 602, which may be a base station 102) and an access point, such as AP 612. The AP 612 may include a connection to the Internet 600 as well as a connection to the N3IWF 603 network entity. The N3IWF may include a connection to the AMF 605 of the 5G CN. The AMF 605 may include an instance of the 5G MM function associated with the STA 106. In addition, the RAN (e.g., gNB 604) may also have a connection to the AMF 605. Thus, the 5G CN may support unified authentication over both connections as well as allow simultaneous registration for STA 106 access via both gNB 604 and AP 612. In addition, the 5G CN may support dual-registration of the wireless device on both a legacy network (e.g., LTE via eNB 602) and a 5G network (e.g., via gNB 604). As shown, the eNB 602 may have connections to a mobility management entity (MME) 642 and a serving gateway (SGW) 644. The MME 642 may have connections to both the SGW 644 and the AMF 605. In addition, the SGW 644 may have connections to both the SMF 606a and the UPF 608a. As shown, the AMF 605 may include one or more functional entities associated with the 5G CN (e.g., NSSF 620, SMSF 622, AF 624, UDM 626, PCF 628, and/or AUSF 630). Note that UDM 626 may also include a home subscriber server (HSS) function, and the PCF may also include a policy and charging rules function (PCRF). Note further that these functional entities may also be supported by the SMF 606a and the SMF 606b of the 5G CN. The AMF 605 may be connected to (or in communication with) the SMF 606a. Further, the gNB 604 may be in communication with (or connected to) the UPF 608a, which may also be communication with the SMF 606a. Similarly, the N3IWF 603 may be communicating with a UPF 608b that may also be communicating with the SMF 606b. Both UPFs may be communicating with the data network (e.g., DN 610a and 610b) and/or the Internet 600 and IMS core network 610.

Note that in various embodiments, one or more of the above-described network entities may be configured to perform methods for increasing traffic separation using additional traffic identifiers (TIDs), as further described herein.

FIG. 7 illustrates an example of a baseband processor architecture for a wireless device (e.g., such as STA 106), according to some embodiments. The baseband processor architecture 700 described in FIG. 7 may be implemented on one or more radios (e.g., radios 429 and/or 430 described above) or modems (e.g., modems 510 and/or 520) as described above. As shown, the non-access stratum (NAS) 710 may include a 5G NAS 720 and a legacy NAS 750. The legacy NAS 750 may include a communication connection with a legacy access stratum (AS) 770. The 5G NAS 720 may include communication connections with both a 5G AS 740 and a non-3GPP AS 730 and Wi-Fi AS 732. The 5G NAS 720 may include functional entities associated with both access stratums. Thus, the 5G NAS 720 may include multiple 5G MM entities 726 and 728 and 5G session management (SM) entities 722 and 724. The legacy NAS 750 may include functional entities such as short message service (SMS) entity 752, evolved packet system (EPS) session management (ESM) entity 754, session management (SM) entity 756, EPS mobility management (EMM) entity 758, and mobility management (MM)/GPRS mobility management (GMM) entity 760. In addition, the legacy AS 770 may include functional entities such as LTE AS 772, UMTS AS 774, and/or GSM/GPRS AS 776.

Thus, the baseband processor architecture 700 allows for a common 5G-NAS for both 5G cellular and non-cellular (e.g., non-3GPP access). The baseband processor architecture 700 can be in communication with one or more UICC(s) 745. Note that as shown, the 5G MM may maintain individual connection management and registration management state machines for each connection. Additionally, a device (e.g., STA 106) may register with a single PLMN (e.g., 5G CN) using 5G cellular access as well as non-cellular access. Further, it may be possible for the device to be in a connected state in one access and an idle state in another access and vice versa. Finally, there may be common 5G-MM procedures (e.g., registration, de-registration, identification, authentication, and so forth) for both accesses.

Note that in various embodiments, one or more of the above-described functional entities of the 5G NAS and/or 5G AS may be configured to perform methods for increasing traffic separation using additional traffic identifiers (TIDs), as further described herein.

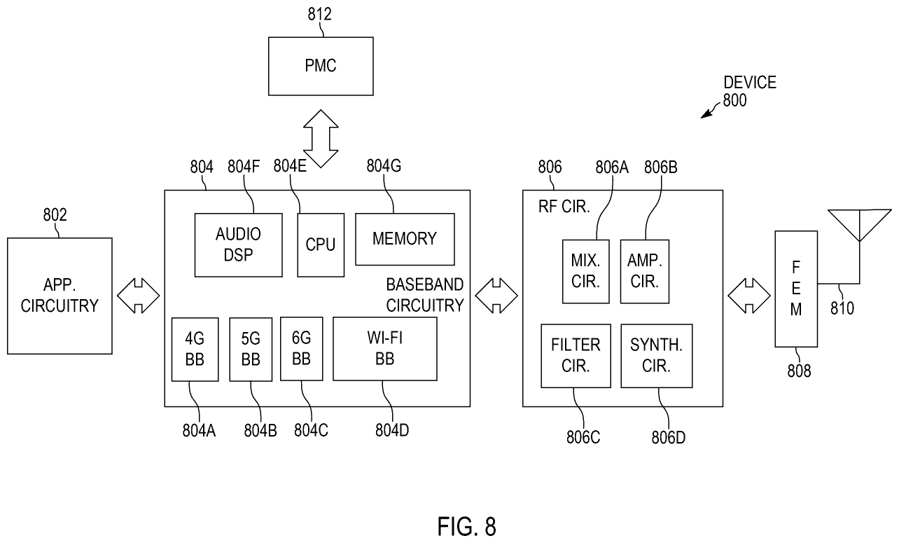

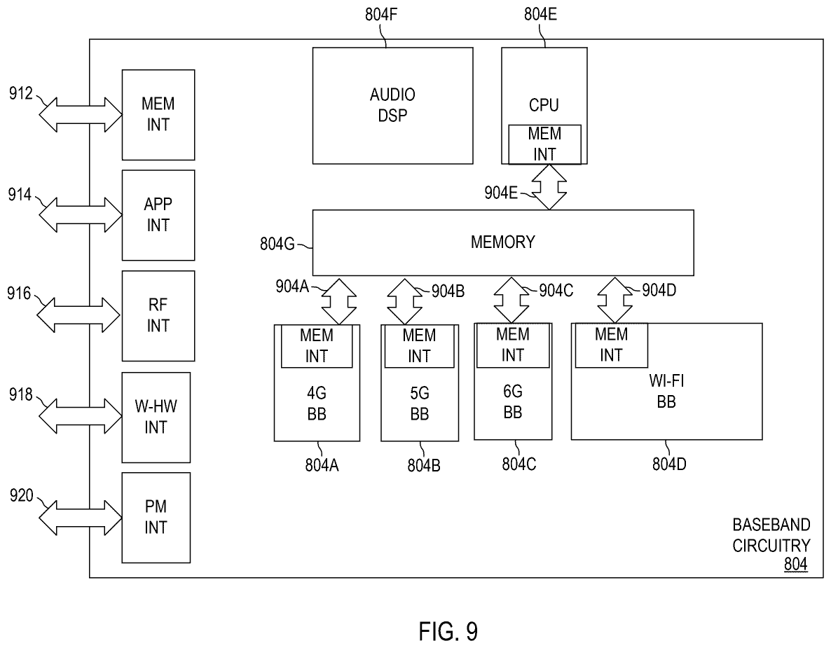

### FIGS. 8 and 9: Device Components

FIG. 8 illustrates example components of a device 800 in accordance with some embodiments. In some embodiments, the device 800 may include application circuitry 802, baseband circuitry 804, Radio Frequency (RF) circuitry 806, front-end module (FEM) circuitry 808, one or more antennas 810, and power management circuitry (PMC) 812 coupled together at least as shown. The components of the illustrated device 800 may be included in a STA or a RAN node. In some embodiments, the device 800 may include less elements (e.g., a RAN node may not utilize application circuitry 802 and instead include a processor/controller to process IP data received from an EPC). In some embodiments, the device 800 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 802 may include one or more application processors. For example, the application circuitry 802 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 800. In some embodiments, processors of application circuitry 802 may process IP data packets received from an EPC.

The baseband circuitry 804 may include circuitry such as, but not limited to, one or more single-core or multi-core processors. The baseband circuitry 804 may include one or more baseband processors or control logic to process baseband signals received from a receive signal path of the RF circuitry 806 and to generate baseband signals for a transmit signal path of the RF circuitry 806. Baseband processing circuitry 804 may interface with the application circuitry 802 for generation and processing of the baseband signals and for controlling operations of the RF circuitry 806. For example, in some embodiments, the baseband circuitry 804 may include a fourth generation (4G) baseband processor 804A, a fifth generation (5G) baseband processor 804B, a sixth generation (6G) baseband processor 804C, a 7^{th} generation (7G) baseband processor and for other existing generations, generations in development or to be developed in the future (e.g., eighth generation (8G), future Wi-Fi Generations, etc.) or a Wi-Fi baseband processor(s) 804D. The baseband circuitry 804 (e.g., one or more baseband processors 804A-D) may handle various radio control functions that enable communication with one or more radio networks via the RF circuitry 806. In other embodiments, some or all of the functionality of baseband processors 804A-D may be included in modules stored in the memory 804G and executed via a Central Processing Unit (CPU) 804E. The radio control functions may include, but are not limited to, signal modulation/demodulation, encoding/decoding, radio frequency shifting, etc. In some embodiments, modulation/demodulation circuitry of the baseband circuitry 804 may include Fast-Fourier Transform (FFT), precoding, or constellation mapping/demapping functionality. In some embodiments, encoding/decoding circuitry of the baseband circuitry 804 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 804 may include one or more audio digital signal processor(s) (DSP) 804F. The audio DSP(s) 804F may include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 804 and the application circuitry 802 may be implemented together such as, for example, on a system on a chip (SOC).

In some embodiments, the baseband circuitry 804 may provide communication compatible with one or more radio technologies. For example, in some embodiments, the baseband circuitry 804 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 804 is configured to support radio communications of more than one wireless protocol may be referred to as multi-mode baseband circuitry.

RF circuitry 806 may enable communication with wireless networks using modulated electromagnetic radiation through a non-solid medium. In various embodiments, the RF circuitry 806 may include switches, filters, amplifiers, etc. to facilitate the communication with the wireless network. RF circuitry 806 may include a receive signal path which may include circuitry to down-convert RF signals received from the FEM circuitry 808 and provide baseband signals to the baseband circuitry 804. RF circuitry 806 may also include a transmit signal path which may include circuitry to up-convert baseband signals provided by the baseband circuitry 804 and provide RF output signals to the FEM circuitry 808 for transmission.

In some embodiments, the receive signal path of the RF circuitry 806 may include mixer circuitry 806a, amplifier circuitry 806b and filter circuitry 806c. In some embodiments, the transmit signal path of the RF circuitry 806 may include filter circuitry 806c and mixer circuitry 806a. RF circuitry 806 may also include synthesizer circuitry 806d for synthesizing a frequency for use by the mixer circuitry 806a of the receive signal path and the transmit signal path. In some embodiments, the mixer circuitry 806a of the receive signal path may be configured to down-convert RF signals received from the FEM circuitry 808 based on the synthesized frequency provided by synthesizer circuitry 806d. The amplifier circuitry 806b may be configured to amplify the down-converted signals and the filter circuitry 806c may be a low-pass filter (LPF) or band-pass filter (BPF) configured to remove unwanted signals from the down-converted signals to generate output baseband signals. Output baseband signals may be provided to the baseband circuitry 804 for further processing. In some embodiments, the output baseband signals may be zero-frequency baseband signals, although this is not a requirement. In some embodiments, mixer circuitry 806a of the receive signal path may comprise passive mixers, although the scope of the embodiments is not limited in this respect.

In some embodiments, the mixer circuitry 806a of the transmit signal path may be configured to up-convert input baseband signals based on the synthesized frequency provided by the synthesizer circuitry 806d to generate RF output signals for the FEM circuitry 808. The baseband signals may be provided by the baseband circuitry 804 and may be filtered by filter circuitry 806c.

In some embodiments, the mixer circuitry 806a of the receive signal path and the mixer circuitry 806a of the transmit signal path may include two or more mixers and may be arranged for quadrature downconversion and upconversion, respectively. In some embodiments, the mixer circuitry 806a of the receive signal path and the mixer circuitry 806a of the transmit signal path may include two or more mixers and may be arranged for image rejection (e.g., Hartley image rejection). In some embodiments, the mixer circuitry 806a of the receive signal path and the mixer circuitry 806a may be arranged for direct downconversion and direct upconversion, respectively. In some embodiments, the mixer circuitry 806a of the receive signal path and the mixer circuitry 806a of the transmit signal path may be configured for super-heterodyne operation.

In some embodiments, the output baseband signals, and the input baseband signals may be analog baseband signals, although the scope of the embodiments is not limited in this respect. In some alternate embodiments, the output baseband signals, and the input baseband signals may be digital baseband signals. In these alternate embodiments, the RF circuitry 806 may include an analog-to-digital converter (ADC) and digital-to-analog converter (DAC) circuitry and the baseband circuitry 804 may include a digital baseband interface to communicate with the RF circuitry 806.

In some dual-mode embodiments, a separate radio IC circuitry may be provided for processing signals for each spectrum, although the scope of the embodiments is not limited in this respect.

In some embodiments, the synthesizer circuitry 806d may be a fractional-N synthesizer or a fractional N/N+1 synthesizer, although the scope of the embodiments is not limited in this respect as other types of frequency synthesizers may be suitable. For example, synthesizer circuitry 806d may be a delta-sigma synthesizer, a frequency multiplier, or a synthesizer comprising a phase-locked loop with a frequency divider.

The synthesizer circuitry 806d may be configured to synthesize an output frequency for use by the mixer circuitry 806a of the RF circuitry 806 based on a frequency input and a divider control input. In some embodiments, the synthesizer circuitry 806d may be a fractional N/N+1 synthesizer.

In some embodiments, frequency input may be provided by a voltage-controlled oscillator (VCO), although that is not a requirement. Divider control input may be provided by either the baseband circuitry 804 or the applications circuitry 802 depending on the desired output frequency. In some embodiments, a divider control input (e.g., N) may be determined from a look-up table based on a channel indicated by the applications circuitry 802.

Synthesizer circuitry 806d of the RF circuitry 806 may include a divider, a delay-locked loop (DLL), a multiplexer and a phase accumulator. In some embodiments, the divider may be a dual modulus divider (DMD), and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 806d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 806 may include an IQ/polar converter.

FEM circuitry 808 may include a receive signal path which may include circuitry configured to operate on RF signals received from one or more antennas 810, amplify the received signals and provide the amplified versions of the received signals to the RF circuitry 806 for further processing. FEM circuitry 808 may also include a transmit signal path which may include circuitry configured to amplify signals for transmission provided by the RF circuitry 806 for transmission by one or more of the one or more antennas 810. In various embodiments, the amplification through the transmit or receive signal paths may be done solely in the RF circuitry 806, solely in the FEM 808, or in both the RF circuitry 806 and the FEM 808.

In some embodiments, the FEM circuitry 808 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 806). The transmit signal path of the FEM circuitry 808 may include a power amplifier (PA) to amplify input RF signals (e.g., provided by RF circuitry 806), and one or more filters to generate RF signals for subsequent transmission (e.g., by one or more of the one or more antennas 810).

In some embodiments, the PMC 812 may manage power provided to the baseband circuitry 804. In particular, the PMC 812 may control power-source selection, voltage scaling, battery charging, or DC-to-DC conversion. The PMC 812 may often be included when the device 800 is capable of being powered by a battery, for example, when the device is included in a UE. The PMC 812 may increase the power conversion efficiency while providing desirable implementation size and heat dissipation characteristics.

While FIG. 8 shows the PMC 812 coupled only with the baseband circuitry 804. However, in other embodiments, the PMC 812 may be additionally or alternatively coupled with, and perform similar power management operations for other components such as, but not limited to, application circuitry 802, RF circuitry 806, or FEM 808.

In some embodiments, the PMC 812 may control, or otherwise be part of, various power saving mechanisms of the device 800. For example, if the device 800 is in an RRC_Connected state, where it is still connected to the RAN node as it expects to receive traffic shortly, then it may enter a state known as Discontinuous Reception Mode (DRX) after a period of inactivity. During this state, the device 800 may power down for brief intervals of time and thus save power.

Processors of the application circuitry 802 and processors of the baseband circuitry 804 may be used to execute elements of one or more instances of a protocol stack. For example, processors of the baseband circuitry 804, (or other functionally similar components), alone or in combination, may be used to execute Layer 3, Layer 2, or Layer 1 functionality, while processors of the application circuitry 804 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer.

FIG. 9 illustrates example interfaces of baseband circuitry in accordance with some embodiments. As discussed above, the baseband circuitry 804 of FIG. 8 may comprise processors 804A-804E and a memory 804G utilized by said processors. Each of the processors 804A-804E may include a memory interface, 904A-904E, respectively, to send/receive data to/from the memory 804G.

The baseband circuitry 804 may further include one or more interfaces to communicatively couple to other circuitries/devices, such as a memory interface 912 (e.g., an interface to send/receive data to/from memory external to the baseband circuitry 804), an application circuitry interface 914 (e.g., an interface to send/receive data to/from the application circuitry 802 of FIG. 8), an RF circuitry interface 916 (e.g., an interface to send/receive data to/from RF circuitry 806 of FIG. 8), a wireless hardware connectivity interface 918 (e.g., an interface to send/receive data to/from Near Field Communication (NFC) components, Bluetooth® components (e.g., Bluetooth® Low Energy), Wi-Fi® components, and other communication components), and a power management interface 920 (e.g., an interface to send/receive power or control signals to/from the PMC 812.

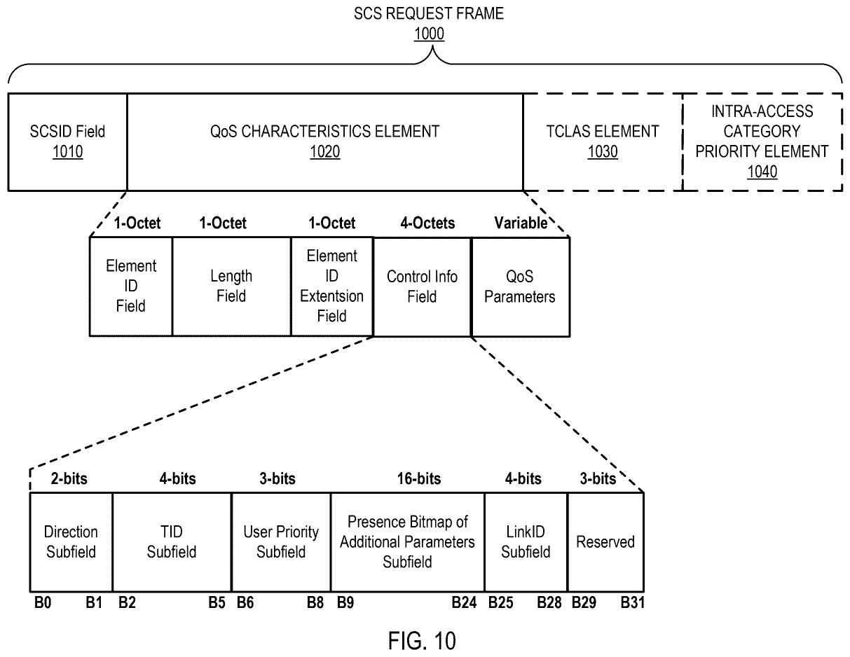

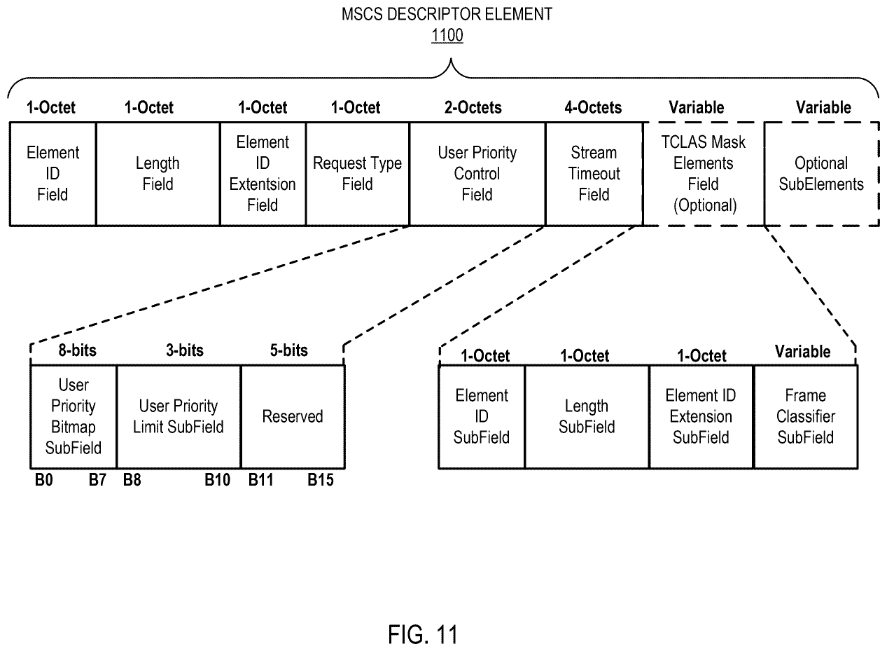

### FIGS. 10 and 11: Stream Classification Service (SCS) and Mirrored Stream Classification Service (MSCS) in Wi-Fi Networks

As described above, STA 106 may be configured to communicate using a Wi-Fi network, where a Wi-Fi network includes a wireless network based on the IEEE 802.11 standards. 802.11 standards provide protocols and operations for a Layer 1 Physical (PHY) Layer and a Layer 2 Data Link Layer (or Media Access Control (MAC) Layer). In general, the Physical Layer relates to physical transmission (e.g., channels, modulation, etc.) and the Data Link Layer relates to physical addressing. In 802.11 standards, the Physical Layer is divided into the following three sub-layers: Physical Layer Convergence Procedure (PLCP), the Physical Medium Dependent (PMD) layer, and the PHY management layer. It should be noted that the Physical Layer in 802.11 standards provides a Physical Layer Protocol Data Unit (PPDU) which is essentially a packet of data transmitted over a Wi-Fi network at the physical layer containing a preamble to initiate communication and the actual data payload. In 802.11 standards, the Data Link Layer is divided into the following three sub-layers: the Logical Link Control (LLC), the MAC sublayer, and the MAC management sub-layer. Further, 802.11 standards provide a Station Management sub-layer for coordinating interactions between the MAC and PHY layers.

802.11 standards support Quality of Service (QoS) management features which support high quality and latency-sensitive applications over a Wi-Fi network. In particular, QoS management features enable traffic flows to be prioritized. For example, 802.11 standards support Enhanced Distributed Channel Access (EDCA) which is a mechanism within a Wi-Fi network that prioritizes different types of traffic by assigning different access parameters based on their priority, allowing for better quality of service (QoS) for applications like voice and video calls by giving them preferential access to the wireless channel compared to regular data traffic. For example, 802.11 standards provide where a Transmission Opportunity (TXOP) is a designated time period where a specific device on a network can transmit data without interruption from other devices. A TXOP essentially gives a device exclusive access to the channel for a set duration and may be used to support Quality of Service (QoS) to prioritize high-priority data transmission and reduce latency.

Two client-centric QoS management features include Stream Classification Service (SCS) and Mirrored Stream Classification Service (MSCS). SCS enables classification and Wi-Fi QoS treatment of specific IP flows, including flows to and from 5G core networks, allowing sensitive traffic from gaming, voice, and video applications to be prioritized over bulk data traffic and the specified QoS Key Performance Indicators (KPIs) to be met. That is, SCS enables STA 106 to request AP 112 apply specific QoS treatment to DL IP data flows using IP classifiers. MSCS allows a client device to request its access point prioritize specific downlink traffic flows by mirroring the priority it assigned to its corresponding uplink traffic, essentially ensuring consistent quality for bidirectional data streams like gaming or video calls by giving priority to the relevant traffic on both send and receive directions. That is, MSCS enables STA 106 to request AP 112 apply specific QoS treatment to DL IP data flows using QoS mirroring.

As described above, SCS enables STA 106 to request AP 112 apply specific QoS treatment to DL IP data flows using IP classifiers. FIG. 10 illustrates an example of a Stream Classification Service (SCS) Request Frame in accordance with some embodiments. As illustrated in FIG. 10, SCS Request Frame 1000 includes SCSID Field 1010 and QoS Characteristics Element 1020. Further, SCS Request Frame 1000 may optionally include Traffic Classification (TCLAS) Element 1030 and Intra-Access Category Priority Element 1040. That is, TCLAS Element 1030 and Intra-Access Category Priority Element 1040 are not included in the SCS Request Frame 1000, if the Direction subfield in the QoS Characteristics element is equal to UL or Direct Link. SCSIC Field 1010 provides an identifier for each SCS stream which is used by a station (STA), (i.e., a device that uses the 802.11 protocol to connect to a Wi-Fi network) to request the creation, modification, or deletion of an SCS stream. TCLAS Element 1030 and Intra-Access Category Priority Element 1040 are included in the SCS Request Frame 1000, if the Direction subfield in the QoS Characteristics element is equal to DL. TCLAS Element 1030 and Intra-Access Category Priority Element 1040 carry user priority fields. For example, TCLAS Element 1030 includes a set of defined parameters that allows an Access Point to identify and categorize incoming traffic streams.

As illustrated in FIG. 10, QoS Characteristics Element 1020 includes Element ID Field, Length Field, Element ID Extension Field, Control Info Field, and QoS Parameters. Element ID Field includes 1-octet and provides an identifier for this element. Length Field includes 1-octet and provides the length of the element. Element ID Extension Field includes 1-octet and provides an extension for an identifier for this element. QoS parameters are variable length and include fields providing QoS parameters. For example, Qos Parameters may include Minimum Service Interval Field, Maximum Service Interval Field, Minimum Data Rate Field, Delay Bound Field, Maximum MAC Service Data Unit (MSDU) Size Field, Service Start Time Field, Service Start Time LinkID Field, Mean Data Rate Field, Delayed Bounded Burst Size Field, MSDU Lifetime Field, MSDU Delivery Info Field and Medium Time Field.

As illustrated in FIG. 10, Control Info Field includes 4-octets and includes Direction subfield, Traffic Identifier (TID) subfield, User Priority subfield, Presence Bitmap of Additional Parameters subField, LinkID subfield, and Reserved bits. Direction subfield includes 2-bits and indicates a direction of MAC Service Data Units (MSDUs) or Aggregated-MAC Service Data Units (A-MSDUs) that are described by the is element. Direction subfield indicates one of UL (MSDUs or A-MSDUs are sent from non-AP STA to the AP), DL (MSDUs or A-MSDUs are sent from the AP to the non-AP STA), or direct link (MSDUs or A-MSDUs are sent over a peer-to-peer link).

User Priority subfield includes 3-bits and includes a user priority value (in the range of 0-7) of the data frames that are described by this element. Traffic Identifier (TID) subfield includes 4-bits and provides the TID value of the data frames that are described by this element. In some versions of 802.11 standards, the value TID subfield is set to the same value as the User Priority field, as such, the values 8-15 are reserved.

Table 1 provides a mapping of Access Categories (AC) to values of the User Priority (UP) field, some versions of 802.11 standards.

TABLE 1

| AC | UP Value | Notes |
|---|---|---|
| AC_BK | 1 | Background Traffic |
| | 2 | Background Traffic |
| AC_BE | 0 | Best Effort Traffic |
| | 3 | Best Effort Traffic |
| AC_VI | 4 | Video Traffic |
| | 5 | Video Traffic |
| AC_VO | 6 | Voice Traffic |
| | 7 | Voice Traffic |

As provide in Table 1, a STA can support up to eight QoS priorities. With respect to Table 1, AC_BK essentially corresponds to the lowest priority data transmission on a Wi-Fi connection and AC_VI and AC_VO correspond to high priority data transmissions.

Referring again to FIG. 10, Presence Bitmap of Additional Parameters subfield includes 16-bits and provides a bitmap where the i^{th} entry of the bitmap is set to 1 if the i^{th} field starting from the Maximum MSDU Size field is present in this element. LinkID subfield includes 2-bits and provides the link identifier of the link for which the direct link transmissions are going to occur. This field is reserved if the Direction subfield is equal to any value other than Direct link. Reserved bits are reserved for future use. In this manner, by transmitting a SCS Request Frame 1000, STA 106 can: (1) Request AP 112 to trigger the client for UL based on the QoS parameters provided in the QoS Characteristics element, and (2) Request AP 112 to classify the DL traffic based on the classifier information provided in the TCLAS Element and assign those to a particular User Priority.

As described above, MSCS enables STA 106 to request AP 112 apply specific QoS treatment to DL IP data flows using QoS mirroring. FIG. 11 illustrates an example of a Mirrored Stream Classification Service (MSCS) Descriptor Element in accordance with some embodiments. A MSCS Descriptor Element is carried in a MSCS Request Frame. As illustrated in FIG. 11, MSCS Descriptor Element 1100 includes Element ID Field, Length Field, Element ID Extension Field, Request Type Field, User Priority Control Field, Stream Timeout Field, Optional TCLAS Mask Elements Field, and Optional SubElements. Each of Element ID Field, Length Field, and Element ID Extension Field include information as described above with respect to FIG. 10. Request Type Field is 1-octet and provides a request type, e.g., creation, modification, or deletion of an MSCS. Stream Timeout Field includes 4-octets and indicates the minimum timeout value. TCLAS Mask Elements Field contains zero or more TCLAS Mask elements to specify how incoming MSDUs are classified into streams in MSCS, i.e., by specifying the Classifier Mask. Optional SubElements include optional subelements.

Referring to FIG. 11, User Priority Control Field includes 2-octets and includes an 8-bit User Priority Bitmap subField, a 3-bit User Priority Limit subField, and 5 reserved bits. Each bit in the User Priority Bitmap subfield corresponds to a user priority (UP), with the least significant bit corresponding to UP value of 0, and the most significant bit corresponding to UP value of 7. A value of 1 in a bit position in the bitmap indicates that the corresponding UP is used when assigning a UP to streams classified by MSCS. The User Priority Limit subfield includes 3-bits and has a value between 0 and 7 that defines the maximum limit for the User Priority that is assigned to incoming MSDUs in the streams classified by MSCS. As such, according to the MSCS procedure, a STA requests the AP to classify the DL traffic based on the classifier information provided in the TCLAS Mask Element Field and assigns those to a particular User Priority. For example, DL traffic may be assigned a UP of 7 instead of 0 based on mirroring. It should be noted that the MSCS Descriptor Element 1100 does not carry the TID information.

As described above, some versions of 802.11 standards enable up to two TIDs for high priority data transmissions. That is, as provided in Table 1, for each of AC_VI and AC_VO two TIDs are provided. Further, in current versions of 802.11 standards, an AP or non-AP STA is required to infer the UP value from the TID in the QoS Control field directly for TID values between 0 and 7. In some cases, for example, for Ultra High Reliability (Wi-Fi 8), 802.11bn, it may be useful to support more than two high priority TIDs. In one example, according to the techniques herein increased traffic separation using additional TID during the SCS and Mirrored SCS (MSCS) procedures may be enabled. In particular, in current versions of 802.11 standards, the TID and the UP subfields are set to the same value in the SCS Request and Response and there is no TID indication in the MSCS Request. According to the techniques described herein, SCS Request and Response procedures and MSCS Request procedures are provided that enable the additional TIDs to be utilized. In one example, according to the techniques described herein, SCS TIDs assigned to AC_BK and/or AC_BE may be remapped in a dynamic manner (e.g., following an SCS flow set up). In one example, according to the techniques herein, the MSCS Request may carry the TID subfield.

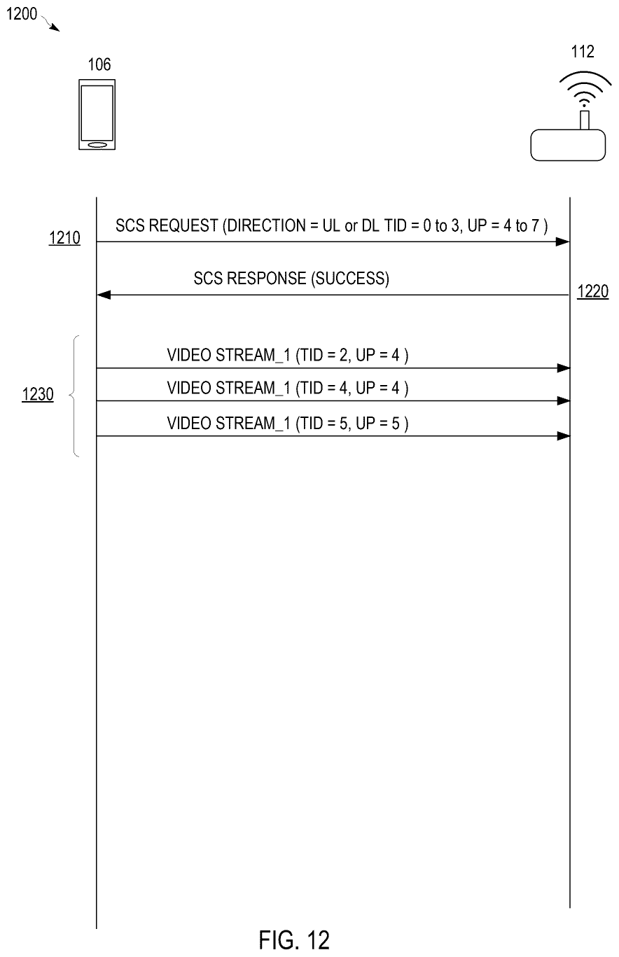

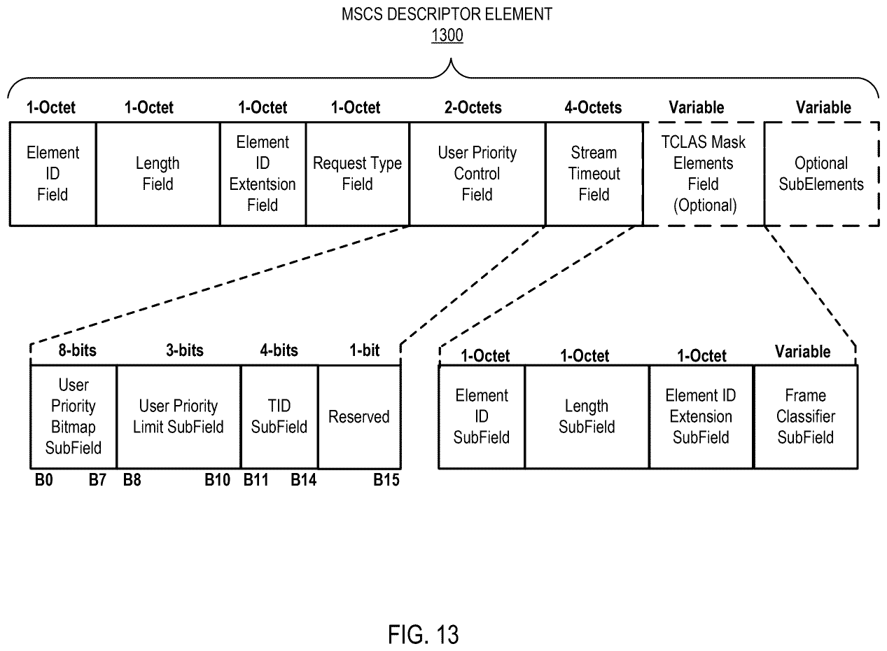

### FIG. 12: Dynamic Mapping of TIDs in a SCS Request

As described above, according to the techniques described herein, SCS Request and Response procedures are provided that enable the additional TIDs to be utilized. In one example, according to the techniques herein, SCS TIDs assigned to AC_BK and/or AC_BE may be remapped dynamically. Table 2 illustrates an example, where a TID for AC_BK is remapped to Video Traffic.

TABLE 2

| | | UP | |
|---|---|---|---|
| AC | TID | Value | Notes |
| AC_BK | 1 | 1 or 2 | Background Traffic. Up to implementation |
| | 2 | 2 | how to map the packets that correspond to |
| | | | background traffic priorities. STA can |
| | | | either keep mapping packets belonging to |
| | | | background traffic to TID 2 or map it to |
| | | | TID 1. |
| AC_BE | 0 | 0 | Best Effort Traffic |
| | 3 | 3 | Best Effort Traffic |
| AC_VI | 2 | 4 or 5 | Video Traffic |
| | 4 | 4 | Video Traffic |
| | 5 | 5 | Video Traffic |
| AC_VO | 6 | 6 | Voice Traffic |
| | 7 | 7 | Voice Traffic |

As described above, in current versions of 802.11 standards, a TID value in a QoS Characteristics Element is required to be equal to a UP value. That is, in current versions of 802.11 standards, if TID is equal to 2, UP is equal to 2. According to the techniques herein, as illustrated in Table 2, for some cases, the TID value in a QoS Characteristics Element may be equal to a value other than the UP value. That is, in the example, illustrated in Table 2, if TID is equal to 1, UP may be equal to 1 or 2 and if TID is equal to 2, UP may be equal to 2, 4, or 5. In this manner, for video traffic, three high priority TIDs are provided (2, 4, and 5). That is, according to the techniques herein, an SCS request frame may include dynamic mapping (e.g., TID=2, UP=4) for EDCA and Triggered Access, thereby increasing the separation for video traffic.

It should be noted that Table 2 provides one example where SCS TIDs assigned to AC_BK and/or AC_BE may be remapped dynamically. In other examples, TID value 0 for AC_BE may be remapped such that when TID is equal to 0, UP may be equal to 0, 6, or 7, which enables three high priority TIDs for Voice traffic. In one example, non-AP STA may request an AP to use additional TIDs for DL and UL direction during an SCS agreement. In one example, according to the techniques herein, the non-AP STA may set the TID and UP subfields in the QoS Characteristics element to distinct values based on the following procedure: (1) set the Direction subfield to indicate Uplink or Downlink; (2) set the TID subfield to the additional TID value (e.g., 0 or 1 or 2 or 3); and (3) set the UP subfield to a UP that corresponds to one of the audio and video priorities (i.e., 4 or 5 or 6 or 7). In one example, after receiving an SCS Response frame from its associated AP with the Status field of the SCS Status duple set to SUCCESS, the STA may initiate transmissions from the additional TID using the EDCA parameters of the access category that corresponds to the UP indicated in the SCS request. For example, in this case, the MPDUs sent from the additional TID may be considered as frames of the primary AC that is associated with the indicated UP in the SCS request and hence can be transmitted in the first PPDU of the TXOP obtained by that AC.

FIG. 12 illustrates an example timing diagram 1200 of Dynamic Mapping of traffic identifiers (TIDs) in a Stream Classification Service (SCS) Request, according to some embodiments. As illustrated in FIG. 12, STA 106 transmits an SCS Request to AP 112 at 1210. STA 106 may transmit a SCS Request frame with a QoS Characteristics element according to the example procedures provided above. For example, direction may be set to UL or DL, TID may be set to a lower priority value, e.g., 0 to 3, and UP may be set to a higher priority value, e.g., 4 to 7. For example, the SCS Request may correspond to the example provided above with respect to Table 2, where TID=2, UP=4. At 1220, AP 112 sends an SCS Response frame with the Status field of the SCS Status duple set to SUCCESS. In this manner, as illustrated in FIG. 12, at 1230, STA 106 may transmit three high priority video streams. That is, as illustrated in FIG. 12 each of TIDs 2, 4, and 5 corresponding to traffic with a UP equal to AC_VI. That is, each of the three streams may be transmitted in the first PPDU of the TXOP obtained by that AC. As such, traffic separation for video traffic is increased.

It should be noted that in other examples, according to the techniques herein, a separate SCS Request with QoS Characteristics Element to indicate the (TID, UP) mapping may be sent. In some examples, according to the techniques herein, a separate management frame (e.g., a frame that is not SCS or MSCS frame) may provide the (TID, UP) mapping. Further, in some examples, according to the techniques herein, the TCLAS element may be used to provide the (TID, UP) mapping.

In this manner, STA 106 represents an example of a device configured to transmit a SCS request frame including a QoS Characteristics Element indicating a TID to UP mapping.

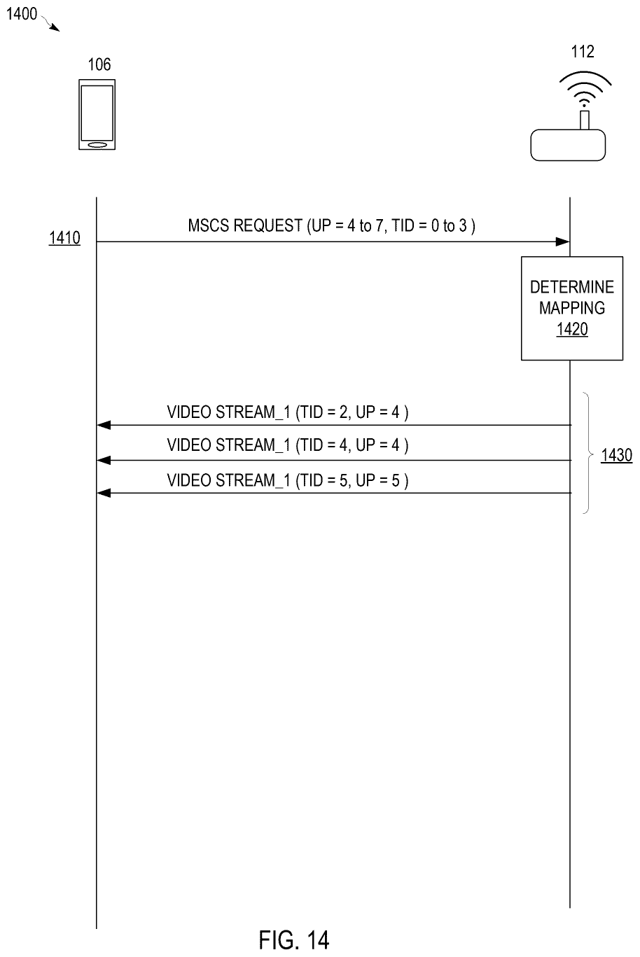

### FIGS. 13 and 14 Signaling TIDs in a MSCS Request

As described above, in one example, according to the techniques herein, the MSCS Request may carry the TID subfield. In one example, the reserved B11-B14 in the User Priority Control field of a MSCS Descriptor Element may be used to indicate a new (UP, TID) mapping. FIG. 13 illustrates an example of a Mirrored Stream Classification Service (MSCS) Descriptor Element in accordance with some embodiments. As illustrated in FIG. 13, MSCS Descriptor Element 1300 includes Element ID Field, Length Field, Element ID Extension Field, Request Type Field, User Priority Control Field, Stream Timeout Field, Optional TCLAS Mask Elements Field, and Optional SubElements. Each of Element ID Field, Length Field, Element ID Extension Field, Request Type Field, Stream Timeout Field, Optional TCLAS Mask Elements Field, and Optional SubElements may include information as described above with respect to FIG. 11.

As illustrated in FIG. 13, bits B11 to B14 of User Priority Control Field include a TID subfield. In one example, the value of the TID subfield may be in the range of 0 to 7, with values 8-15 reserved. Thus, MSCS Descriptor Element 1300 may indicate a TID value using bits B11 to B14. In this manner, according to the techniques herein, the User Priority Control Field may provide a mapping of a TID to a UP value. For example, the TID subfield may be set to 2 and the UP value may be set to 4, based on the MSCS Request Frame. In this manner, for the additional TID (e.g., TID 2 of AC_BK) that is repurposed for the flow separation, an AP may learn the UP mapping of the flows from the MPDUs with the TID value equal to that indicated in the MSCS Request.

FIG. 14 illustrates an example timing diagram 1400 of Dynamic Mapping of traffic identifiers (TIDs) in a Mirrored Stream Classification Service (MSCS) Request, according to some embodiments. As illustrated in FIG. 14, STA 106 transmits an MSCS Request to AP 112 at 1410. STA 106 may transmit a MSCS Request frame with a MSCS Descriptor Element according to the example procedures provided above. For example, a MSCS Request frame may include MSCS Descriptor Element 1300. Thus, in one example, MSCS Request frame may correspond to a higher priority value, e.g., 4 to 7 and TID subfield may be set to a lower priority value, e.g., 0 to 3. For example, the MSCS Request may correspond to the example provided above with respect to Table 2, where TID=2, UP=4. At 1420, AP 112 determines the mapping of the AC to the TID. In this manner, as illustrated in FIG. 14, at 1430, AP 112 may transmit three high priority video streams. That is, as illustrated in FIG. 14 each of TIDs 2, 4, and 5 corresponding to traffic with a UP equal to AC_VI. That is, each of the three streams may be transmitted according to an AC_VI priority. As such, according to the techniques herein, traffic separation may be increased.

It should be noted that noted that in some examples, according to the techniques herein, a QoS Characteristics Element, e.g., the QoS Characteristics Element described above with respect to FIGS. 10 and 12 and Table 2 may be included in a MSCS request frame. That is, MSCS request frame may include a QoS Characteristics Element that provides a TID to UP mapping.

In this manner, AP 112 represents an element of a device configured to receive a MSCS request frame including a user priority control field indicating a TID to UP mapping.

In this manner, STA 106 represents an example of a device configured to transmit a MSCS request frame including a user priority control field indicating a TID to UP mapping.

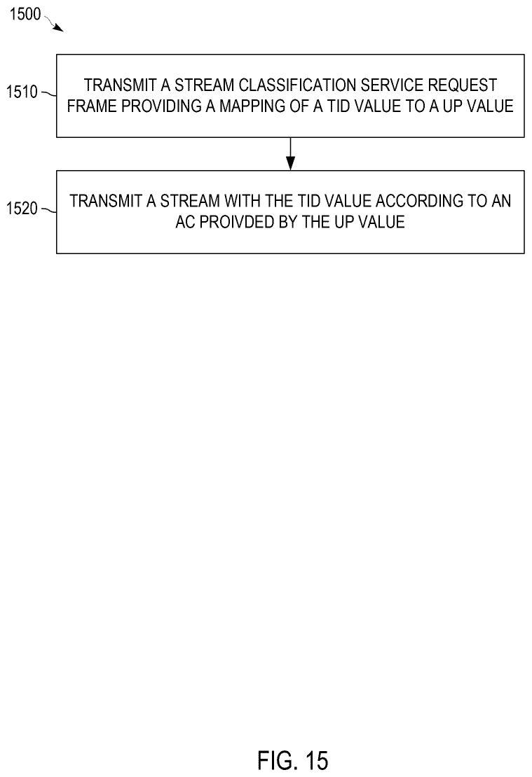

### FIGS. 15-17: Methods for Performing Traffic Separation Using Additional Traffic Identifiers in a Wireless Communication Network.

FIG. 15 illustrates a block diagram of an example of a method 1500 for performing traffic separation using additional traffic identifiers in a wireless communications network, according to some embodiments. The method shown in FIG. 15 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1510, a device in a wireless communications network, for example, a wireless device, such as STA 106, transmits a stream classification service request frame providing a mapping of a transmission identifier value (TID) to a user priority (UP) value. For example, a STA may transmit a SCS request frame including a QoS Characteristics Element indicating a TID to UP mapping, as described above. For example, a STA may transmit a MSCS request frame including a user priority control field indicating a TID to UP mapping, as described above.

At 1520, the wireless device may transmit a stream with the transmission identifier value (TID) according to the access category (AC) provided by the user priority (UP). For example, a STA may transmit a stream according to a high priority access category as described above.

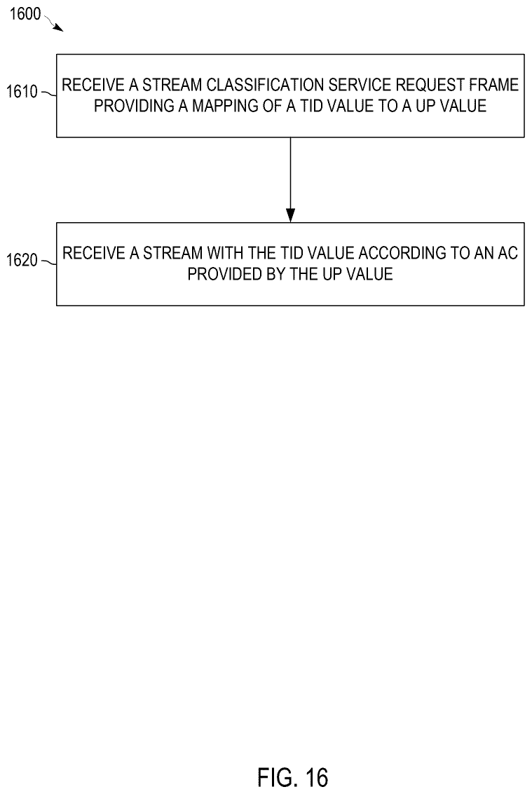

FIG. 16 illustrates a block diagram of an example of a method 1600 for performing traffic separation using additional traffic identifiers in a wireless communications network, according to some embodiments. The method shown in FIG. 16 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1610, a device in a wireless communications network, for example, AP 112, receives a stream classification service request frame providing a mapping of a transmission identifier value (TID) to a user priority (UP) value. For example, an AP may receive a SCS request frame including a QoS Characteristics Element indicating a TID to UP mapping, as described above. For example, an AP may receive an MSCS request frame including a user priority control field indicating a TID to UP mapping, as described above.

At 1620, the device may receive a stream with the transmission identifier value (TID) according to the access category (AC) provided by the user priority (UP). For example, an AP may receive a stream with according to a high priority access category as described above.

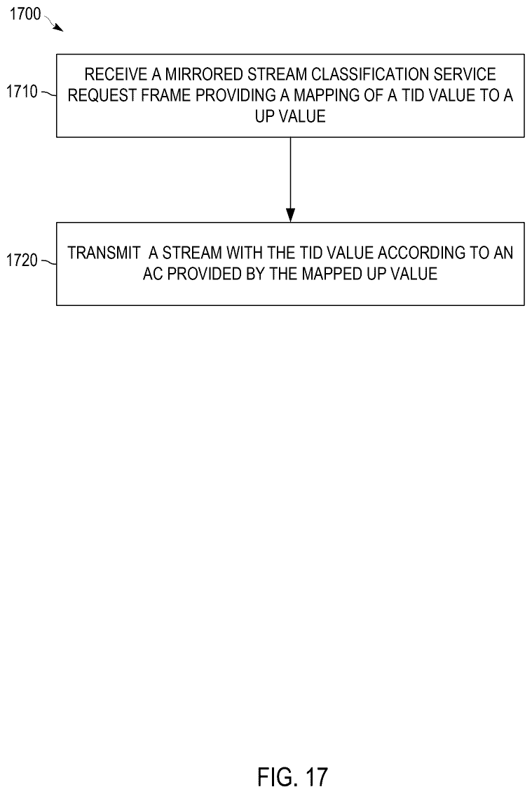

FIG. 17 illustrates a block diagram of an example of a method 1700 for performing traffic separation at a wireless device using additional traffic identifiers in a wireless communications network, according to some embodiments. The method shown in FIG. 17 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1710, a device in a wireless communications network, for example, AP 112, receives a mirrored stream classification service request frame providing a mapping of a transmission identifier (TID) value to a user priority (UP) value to form a mapped UP value by setting a TID subfield to a first value. For example, an AP may receive a mirrored SCS request frame including a QoS Characteristics Element indicating a TID to UP mapping, as described above. For example, an AP may receive a MSCS request frame including a user priority control field indicating a TID to UP mapping, as described above.

At 1720, the device may transmit a stream with the transmission identifier value (TID) according to the access category (AC) provided by the mapped user priority (UP) value. For example, an AP may transmit a stream according to a high priority access category as described above.

In some examples, transmitting a stream with the traffic identifier (TID) value according to an access category provided by the user priority (UP) value may include transmitting the stream in a first Physical Layer Protocol Data Unit (PPDU) of the Transmission Opportunity (TXOP) obtained by the access category.

In some examples, a method for performing traffic separation using additional traffic identifiers in a wireless communications network further includes receiving a stream classification service request frame indicating a success status.

In some examples, a mapping of a traffic identifier (TID) value to a user priority (UP) value is indicated by a traffic identifier (TID) subfield set to a first value and a user priority (UP) subfield set to a distinct second value.

In some examples, the traffic identifier (TID) is mapped to a high priority access category.

In some examples, the high priority access category includes a video traffic access category.

In some examples, the high priority access category includes a voice traffic access category.

In some examples, the traffic identifier (TID) subfield and the user priority (UP) subfield are included in a control information field.

In some examples, the control information field includes a direction subfield, and the direction subfield is set to uplink (UL) transmissions.

In some examples, the control information field includes a direction subfield, and the direction subfield is set to downlink (DL) transmissions.

In some examples, the control information field is included in a quality of service (QoS) element.

In some examples, the traffic identifier (TID) subfield and the user priority (UP) bitmap subfield are included in a user priority control field.

In some examples, the user priority control field is 16 bits, and the traffic identifier (TID) subfield is included in bits 11 to 14.

In some examples, the user priority control field is included in a Mirrored Stream Classification Service (MSCS) descriptor element.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a STA 106) may be configured to include a processor (or a set of processors) including one or more baseband processors and one or more application processors and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Any of the methods described herein for operating a wireless device (STA) may be the basis of a corresponding method for operating a base station, by interpreting each message/signal X received by the STA in the downlink as message/signal X transmitted by the base station, and each message/signal Y transmitted in the uplink by the STA as a message/signal Y received by the base station.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for performing traffic separation at a wireless device using additional traffic identifiers in a wireless communications network, the method comprising:
transmitting a stream classification service (SCS) request frame providing a mapping of a traffic identifier (TID) value to a user priority (UP) value to form a mapped UP value by setting a TID subfield to a first value and setting a UP subfield to a distinct second value; and
transmitting a stream with the TID value according to an access category provided by the mapped UP value.

2. The method of claim 1, wherein transmitting a stream according to an access category includes transmitting the stream in a first Physical Layer Protocol Data Unit (PPDU) of a Transmission Opportunity (TXOP) obtained by the access category.

3. The method of claim 1, further comprising receiving an SCS response frame indicating a success status.

4. The method of claim 1, wherein the distinct second value corresponds to a high priority access category.

5. A method for performing traffic separation at an access point (AP) using additional traffic identifiers in a wireless communications network, the method comprising:
receiving a stream classification service (SCS) request frame providing a mapping of a traffic identifier (TID) value to a user priority (UP) value to form a mapped UP value, wherein the mapping is indicated by a TID subfield set to a first value and a user priority (UP) subfield set to a distinct second value; and
receiving a stream with the TID value according to an access category provided by the mapped UP value.

6. The method of claim 5, wherein the distinct second value corresponds to a high priority access category.

7. The method of claim 6, wherein the high priority access category includes a video traffic access category.

8. The method of claim 6, wherein the high priority access category includes a voice traffic access category.

9. The method of claim 8, wherein the TID subfield and the UP subfield are included in a control information field.

10. The method of claim 9, wherein the control information field includes a direction subfield, and the direction subfield is set to uplink (UL) transmissions.

11. The method of claim 9, wherein the control information field includes a direction subfield, and the direction subfield is set to downlink (DL) transmissions.

12. The method of claim 11, wherein the control information field is included in a quality of service (QoS) element.

13. A method for performing traffic separation at a wireless device using additional traffic identifiers in a wireless communications network, the method comprising:
receiving a Mirrored Stream Classification Service (SCS) request frame providing a mapping of a traffic identifier (TID) value to a user priority (UP) value to form a mapped UP value by setting a TID subfield to a first value; and
transmitting a stream with the TID value according to an access category provided by the mapped UP value.

14. The method of claim 13, wherein the TID subfield is included in a user priority control field.

15. The method of claim 14, wherein the user priority control field is 16 bits, and the traffic identifier (TID) subfield is included in bits 11 to 14 of the user priority control field.

16. The method of claim 15, wherein the user priority control field is included in a Mirrored Stream Classification Service (MSCS) descriptor element.

17. The method of claim 13, wherein the TID subfield is included in a quality of service (QoS) element.

18. The method of claim 17, wherein the TID value is mapped to a high priority access category.

19. The method of claim 18, wherein the high priority access category includes a video traffic access category.

20. The method of claim 18, wherein the high priority access category includes a voice traffic access category.
